(19) United States
(12) Patent Application Publication
(10) Pub. No.: US 2009/0148584 A1
(43) Pub. Date: Jun. 11, 2009

(54) ENDURANCE BAR

(75) Inventor: Roderick Fredrick Gerardus Joseph King, West Yorkshire (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: GALACTOGEN PRODUCTS LIMITED, London (GB)

(21) Appl. No.: 11/719,591

(22) PCT Filed: Nov. 21, 2005
(86) PCT No.: PCT/GB05/04462

§ 371 Date: May 17, 2007

(30) Foreign Application Priority Data
Nov. 19, 2004 (GB) 0425517.0

(51) Int. Cl. A23L 1/29; A23L 1/09; A23L 1/305

(52) U.S. Cl. 426/583

(57) ABSTRACT

A nutritional composition for enhancing endurance comprising one or more carbohydrates including galactose, fat, protein, fibre, and optional further ingredients, wherein the ratio of carbohydrates: protein is in the range of about 2:1 to about 4:1 and wherein at least 50% of the protein is selected from a group consisting of: whey protein, casein, whey protein hydrolysate, wheat protein hydrolysate and mixtures thereof.

This invention relates to a food product, particularly but not exclusively to an edible bar, gum or chew to improve the mental and physical alertness, resistance to fatigue and maintenance or enhancement of a state of endurance of a user. The product may serve to improve the mental and physical well-being of a user, delaying or preventing the onset of fatigue. The rate and duration of energy provision may be extended. Preferred products provide enhanced maintenance and repair of tissues which may be damaged during exertion.

Fatigue can be described as the state arising when essential and peripheral pathways responsible for the maintenance of pace are no longer able to sustain that pace with the result that there is a progressive slow down and reluctance to be active. In such a situation enhanced endurance is the combination of complete functional mental and physical activities such that the onset of fatigue is delayed and pace is maintained or that the loss of pace is reduced. This may be coupled with a full functional ability to provide energy. However, an empirical combination of ingredients has been found to be prone to failure because combinations do not always act summatively and may even act antagonistically. Neglect of the combination of substrates with which endurance is affected may lead to situations in which use of effective substances is sub-optimal because co-ordinated function is reduced.

Exercise places considerable demands on the use of fuels to provide energy for working muscle and other tissues, and building blocks to maintain cellular function in all tissues to support normal body activity. These fuels and building blocks can be obtained from both endogenous and exogenous substrates primarily in the form of glycogen in liver and muscle, glucose, fatty acids and amino acids in plasma, lipids in adipose tissue and muscle, and proteins. Tissues are unable to function without at least one source of fuel and are only able to function maximally when one or more source is available. There may be restrictions on both the intensity and endurance of normal activities because each fuel source is only of a finite size. The human body changes in periods between meals and reserves may become depleted. The provision of specific nutrients is beneficial because the substrates supplement those used from the bodies endogenous sources. Provision of selected nutrients can improve endurance.

According to the present invention a nutritional composition for enhancing endurance comprises one or more carbohydrates including galactose, fat, protein, fibre, and optional further ingredients,
wherein the ratio of carbohydrates: protein is in the range of about 2:1 to about 4:1 and wherein at least 50% of the protein is selected from a group consisting of: whey protein, casein, whey protein hydrolysate; wheat protein hydrolysate and mixtures thereof.

In preferred embodiments the ratio of carbohydrate to protein is in the range of about 2.5:1 to about 3.5:1, preferably about 2.7:1 to about 3.2:1, more preferably about 3:1.

In preferred embodiments of the invention carbohydrates are selected from the group consisting of galactose, glucose, corn starch; maltodextrin, starch, raw cane sugar, fructose syrup; refined cane sugar and mixtures thereof.

In an alternative embodiment of the invention glucose and sucrose are absent.

In preferred embodiments of the invention the food comprises an edible bar, gum, chew or powder composition for making into a drink. The size of the product is preferably selected so that consumption of up to about five portions, depending on the duration of activity, would afford an adequate dosage. For example 50-60 g or 100 g bars may be provided.

Preferably the amount of carbohydrate is 40 to 75%. That is for example in a 100 g bar the amount of carbohydrate will be 40 to 75 g.

Percentages and other proportions referred to in the specification are by weight unless indicated otherwise. The percentages and proportions are selected to total 100%.

The fat preferably comprises both saturated and unsaturated species. An amount of about 0.05 to about 10% of fat is preferred. Preferred products include from about 5 to 10% of mono and saturated fatty acids (MUFA) and from about 10 to about 15% of poly unsaturated fatty acids (PUFA).

Preferred products contain from about 0.05 to about 10% of a mixture of soluble and insoluble fibre. Preferred products contain from about 14 to about 25% of protein. Animal or vegetable protein or mixtures thereof may be employed. A proportion of the protein may be present as protein hydrolysate.

The galactose may be present in part or entirely in the form of date or fig paste or other syrups. Food concentrates may also be employed.

The poly-saccharides may be obtained from a combination of sources including corn starch, seeds, flour, rice, rolled oats, fruit and nuts. Dried and preserved fruit may be employed.

Part of the fructose requirement may be in the form of HFCS, fruit concentrates or syrups.

Part of the glucose requirement may be in the form of brown rice syrup or other syrups.

The hydrolysed lactose may be obtained as a galactose/glucose syrup or derivative thereof with approximately 40-50% galactose and variable glucose and fructose content. The lactose may be provided as hydrolysed lactose syrup. The fat requirement may be provided in the form of flaxseed, sunflower, fish, olive or other vegetable or animal oils.

The soluble and insoluble fibre may be provided for example as oat bran. A proportion of the fibre content may be provided as pectin.

The minerals include Fe, Zn, Ca and other essential minerals.

Stabilisers which may be employed include citrate, phosphate and other butter systems.

Part of the phosphatidyl choline may be provided as egg or soy lecithin.

Caffeine when employed may be provided as a mixture of caffeine and/or naturally obtaining caffeine containing products, for example guarana.

Antioxidants which may be used include green tea extracts and soy isoflavones.

Wholesome fruit may be dried or partially dried and may be used to provide a proportion of the carbohydrate protein fibre antioxidants and minerals. Wholesome nuts may be used or nut free products may be provided. Stabilisers and preservatives may be used as necessary.

The invention as further described by means of example were not in any limitative sense.

Table 1 discloses both specific examples and general ranges for endurance bars in accordance with this invention.

TABLE 1

| | | | | | | | General Range | | |
|---|---|---|---|---|---|---|---|---|---|
| | | | | | | | Lower Limit- | Preferred | Model |
| Ingredient | A | B | C | D | E | F | Upper limit | range | Bar |
| Galactose | 5 | 20 | — | 5 | 5 | — | 5-37.5 | 10-30 | 14.4 |
| Polysaccharides | 18 | 8 | 18 | 28 | 22 | 22 | 5-30 | 7-25 | 8.9 |
| Maltodextrin | 10.5 | 5.5 | 10.5 | 0.5 | 10.5 | 10.5 | 3-30 | 3.5-15 | 3.8 |
| Raw Cane Sugar | 1 | 1 | 1 | 1 | 1 | 1 | 1-10 | 1.5-8 | 1.9 |
| Fructose | 3 | 3 | 3 | 3 | 3 | 3 | 0.5-10 | 0.75-7 | 0.96 |
| Refined Cane Sugar | 3 | 3 | 3 | 3 | 3 | 3 | 1-20 | 1.25-10 | 1.42 |
| Glucose | 5 | 5 | — | 5 | 5 | — | 1.5-15 | 1.25-10 | 1.42 |
| Hydrolysed Lactose | — | — | 10 | — | — | 10 | 5-50 | 5-40 | 9.6 |
| Lactose | — | — | — | — | 1 | 1 | 0.5-2 | 0.75-1.5 | 0.96 |
| Sodium Pyruvate | 2 | 2 | 2 | 2 | 2 | 2 | 1-7 | 2-4 | 2.5 |
| Fat (proportions of | 10 | 10 | 10 | 10 | 10 | 10 | 5-30 | 7-15 | 9.6 |
| Monounsaturated | | | | | | | | | |
| fatty acids (MUFA) | | | | | | | | | |
| and Polyunsaturated | | | | | | | | | |
| acids (PUFA) are | | | | | | | | | |
| 5-10% and 10-15% | | | | | | | | | |
| respectively of | | | | | | | | | |
| the total energy | | | | | | | | | |
| content) | | | | | | | | | |
| Conjugated | — | — | — | — | 1 | 1 | 0.5-2 | 1-1.5 | 1 |
| Linoleic Acid (CLA) | | | | | | | | | |
| Fibre (Sol&Insol) | 5 | 5 | 5 | 5 | 5 | 5 | 2-10 | 5-8 | 5.7 |
| Vitamins | 10-100% | 10-100% | 10-100% | 10-100% | 10-100% | 10-100% | 10-100% | 40-60% | 50% |
| | RDA | RDA | RDA | RDA | RDA | RDA | RDA | RDA | RDA |
| Protein | 11 | 11 | 11 | 11 | 11 | 11 | 6-30 | 7-24 | 7.8 |
| Branched Chain | 5 | 5 | 5 | 5 | 5 | 5 | 3-21 | 5-15 | 6 |
| Amino Acids (BCAA) | | | | | | | | | |
| HydroxyMethyl | 1.5 | 1.5 | 1.5 | 1.5 | 1.5 | 1.5 | 1-3 | 1.5-2 | 1.5 |
| Butyrate (HMB) | | | | | | | | | |
| L-carnitine | 1 | 1 | 1 | 1 | 1 | 1 | 0.5-2 | 1-2 | 1 |
| Flavours | 1 | 1 | 1 | 1 | 1 | 1 | 1 | 1 | 1 |
| Minerals | 0-100% | 0-100% | 0-100% | 0-100% | 0-100% | 0-100% | 10-100% | 40-60% | 50% |
| | RDA | RDA | RDA | RDA | RDA | RDA | RDA | RDA | RDA |
| Stabilisers | 2 | 2 | 2 | 2 | 2 | 2 | 2 | 2 | 2 |
| Water | 11 | 11 | 11 | 11 | 5 | 5 | 2-20 | 5-15 | 10 |
| Sodium/Potassium | 1 | 1 | 1 | 1 | 1 | 1 | 1-4 | 2-3 | 2 |
| dhydrogen or | | | | | | | | | |
| hydrogen phosphate | | | | | | | | | |
| Sodium Bicarbonate | 3 | 3 | 3 | 3 | 3 | 3 | 1-21 | 3-15 | 5 |
| Phosphatidyl serine | 0.150 | 0.150 | 0.150 | 0.150 | 0.150 | 0.150 | 0.050-0.350 | 0.125-0.175 | 0.15 |
| Phosphatidyl choline | 0.125 | 0.125 | 0.125 | 0.125 | 0.125 | 0.125 | 0.050-0.250 | 0.100-0.175 | 0.125 |
| Vitamin E | 200 | 200 | 200 | 200 | 200 | 200 | 50-400 | 150-250 | 200 |
| | IU | IU | IU | IU | IU | IU | IU | IU | IU |
| Vitamin C | 0.125 | 0.125 | 0.125 | 0.125 | 0.125 | 0.125 | 0.050-0.500 | 0.100-0.200 | 0.150 |
| Caffeine | 0.100 | 0.100 | 0.025 | 0.025 | 0.050 | 0.050 | 0.010-0.200 | 0.025-0.100 | 0.050 |
| Other antioxidants | 0.1 | 0.1 | 0.1 | 0.1 | 0.1 | 0.1 | 0.1-0.2 | 0.13-017 | 0.15 |
| Ginseng | 0.1 | 0.1 | 0.1 | 0.1 | 0.1 | 0.1 | 0.1-1 | 0.25-0.75 | 0.5 |

Ingredients are given by mass (g or mg). Vitamins by mg or IU or % RDA, variation will occur depending on specific type of bar.

Examples above are based on 100 g ingredients. The suggested bar is 50-60 g.

The carbohydrate protein ratio should be within the range 2:1 to 4:1 by energy or mass. This is 48-57.6% carbohydrate, 24-14.4% protein, 28% fat on an energy basis (ie by proportion of the total macronutrient energy available). Since fat has approximately twice the calorific value of carbohydrate or protein, this equates to 56.9-68.2% carbohydrate, 28.4-17.1 % protein, 14.7% fat on a mass basis of macronutrients (ie by dry weight of macronutrients but not by weight of bar containing variable amount of moisture). However the ratio of carbohydrate to protein may be 3:1 with variation of fat from 15%-45% on an energy basis or 7.3%-26.7% on a mass basis.

The carbohydrate protein ratio in the preferred embodiment is 3:1 on an energy or by mass basis. Preferably this is 54% carbohydrate, 18% Protein, 28% fat on an energy basis (ie by proportion of the total macronutrient energy available). Since fat has approximately twice the calorific value of carbohydrate or protein, this equates preferably to 64% carbohydrate, 21.3% Protein, 14.7% fat on a mass basis of macronutrients (ie by dry weight of macronutrients but not by weight of bar containing variable amount of moisture).

The specific carbohydrates include all those above (both as pure saccharides or wholesome organic nutrients) to yield or produce by digestion or otherwise monosaccharides to include galactose, glucose and fructose. The ratio of content (mono, di, oligo, poly and complex saccharides of each type, % by weight) is 14% to 59% by weight galactose yielding, 71%-29% by weight glucose yielding, 15%-12% fructose yielding (to achieve 100% by weight of carbohydrate content). The preferred embodiment is 30% by weight galactose yielding, 60% by weight glucose yielding, 10% by weight fructose yielding. Of this at least 90% of the galactose content should be in the form of monosaccharide or free galactose.

Within the proportions described, that part as galactose may be largely in the form of monosaccharides (14% to 59% by weight of total carbohydrate content) and that part yielding glucose (71%-29% by weight of total carbohydrate content) as a mixture of monosaccharide and higher saccharides of ratio 1:4 (20% by weight of glucose yielding content as free glucose, and 80% by weight of glucose yielding content as higher saccharides) such that in the total carbohydrate mix the amount of free glucose as monosaccharide is no more than 40% of the galactose content and no more than 20% of the glucose yielding higher saccharide content. In such a mixture the preferred embodiment is a galactose:glucose monosaccharide:glucose yielding higher saccharide:fructose mix of 29.4% galactose by weight, 11.8% free glucose by weight, 47% higher glucose yielding saccharides by weight, 11.8% fructose by weight.

Within the proportions described, 10%-50% by mass of the fat content, (given above to range from 7.3%-26.7% by weight of macronutrients), may be in the form of monounsaturated (MUFA) and polyunsaturated (PUFA) fatty acids, ie the combined proportions of MUFA and PUFA is 0.73%-13.35% by weight of macronutrients wherein MUFA is 0.18% to 6.68% and PUFA is 0.36% to 10% by weight of macronutrients such that the sum of MUFA and PUFA is in the range 0.73% to 13.35% by weight (ie a resulting ratio of MUFA to PUFA between 1:3 and 1:1).

The proportion of protein to carbohydrate (total as above), is preferred at 1:3 by energy. 20-70% of the protein content, preferably 50% should be whey and casein of variable proportion, (caseinates may be used in part). 80-30% of the protein content may be from natural products such as nuts, seeds and flour ) e.g. soy flour), also from soy or rice protein. Part of the protein content may be added as a hydrolysate e.g. wheat protein hydrolysate.

Flavourings may be added as necessary e.g. lemon, lime, blackcurrant, orange, citrus, cranberry, chocolate. The mixture is formulated such that these constituents give bars that range from chewy to dry according to taste. The water content may be varied as required to produce any particular texture of product. Suggested size and mass for energy bars could range from 50 g to 150 g. A typical bar may be 100 g of mixed ingredients.

1. A nutritional composition for enhancing endurance comprising one or more carbohydrates including galactose, fat, protein, fibre, and optional further ingredients, wherein the ratio of carbohydrates: protein is in the range of about 2:1 to about 4:1 and wherein at least 50% of the protein is selected from a group consisting of: whey protein, casein, whey protein hydrolysate; wheat protein hydrolysate and mixtures thereof.

2. A composition as claimed in claim 1 wherein the ratio of carbohydrate to protein is in the range of about 2.5:1 to about 3.5:1.

3. A composition as claimed in claim 2 wherein the ratio of carbohydrate to protein is in the range of about 2.7:1 to about 3.2:1.

4. A composition as claimed in claim 3 wherein the ratio of carbohydrate to protein is in the range of about 3:1.

5. A composition as claimed in claim 1 wherein the one or more carbohydrates are selected from the group consisting of galactose, glucose, corn starch; maltodextrin, starch, raw cane sugar, fructose syrup; refined cane sugar and mixtures thereof.

6. A composition as claimed in claim 5 which is free from glucose and sucrose.

7. A composition as claimed in claim 1 comprising an edible bar, gum, chew or powder composition for making into a drink.

8. A composition as claimed in claim 1 wherein the amount of carbohydrate is from about 40% to about 75%.

9. A composition as claimed in claim 1 wherein the amount of fat is from about 0.05% to about 10%.

10. A composition as claimed in claim 1 containing from about 5% to about 10% of monounsaturated fatty acid and from about 10% to about 15% of polyunsaturated fatty acid.

11. A composition as claimed in claim 1 containing from about 0.05% to about 10% of a mixture of soluble and insoluble fibre.

12. A composition as claimed in claim 1 containing from about 14% to about 25% protein.

13. A composition as claimed in claim 12 in which the protein is animal or vegetable protein or a mixture thereof.

14. A composition as claimed in claim 13 wherein a proportion of the protein is protein hydrolysate.

15. A composition as claimed in claim 1 wherein the galactose in part or entirely comprises date or fig paste or other syrup.
